(19) United States
(12) Patent Application Publication
(10) Pub. No.: US 2014/0266612 A1
(43) Pub. Date: Sep. 18, 2014

(54) PASSIVE NEAR FIELD ID FOR CORRELATING ASSET WITH MOBILE TRACKER

(71) Applicant: Novatel Wireless, Inc., San Diego, CA (US)

(72) Inventors: David Gordon Marten, Sachse, TX (US); Charles Chapman Moore, Plano, TX (US)

(73) Assignee: Novatel Wireless, Inc., San Diego, CA (US)

(21) Appl. No.: 13/797,318

(22) Filed: Mar. 12, 2013

(51) Int. Cl. G06K 7/10

(52) U.S. Cl. CPC G06K 7/10009
USPC 340/10.1

(57) ABSTRACT

An asset tracking system, comprising an asset; a tag comprising a tag identifier, the tag associated with the asset; a tracker comprising: a device identifier, a reader configured to read the tag identifier from the tag, and a transmitter configured to transmit the tag identifier and the device identifier to a server; a server configured to receive the transmitted tag identifier and device identifier, to associate them with each other, and to store the tag identifier, device identifier, and the association in a database.

### BACKGROUND

1. Field of the Invention

The embodiments described herein relate generally to the field of inventory tracking, and more particularly to systems and methods for improved asset tracking where the tracking device is temporarily removed, or disassociated with the assets being tracked.

2. Related Art

In conventional systems of inventory tracking, an item that is being tracked (e.g., a suitcase, box, file cabinet, pallet, or other container) is often referred to as an asset. Moreover, an asset may have a number of separately trackable smaller items contained within it, or it may have removable subcomponents that are necessary for the device to function (such as a plug-in module, a battery pack, cartridge, clip, disc, or other connectable unit), or the item may simply have a number of separately trackable items associated with it, even if such items are not physically contained within the item being tracked (e.g., various markers associated with a whiteboard). For the purposes of this discussion, such items as well as any associated items, subcomponents, and contained items will be referred to collectively as “assets.”

In such conventional systems of inventory tracking, each asset that is separately trackable will often be “tagged”, e.g., with an Radio Frequency Identification (RFID) or other type of near field communication technology tag. The tag will conventionally store an identifier that identifies the asset. A tracking device that can read the tag and therefore the asset identifier can then be used to track the asset and communicate information related thereto to a server. Conventionally, the tracking device will also have a device identifier and the association between the tracking device identifier and any associated asset(s) has to be manually logged into a database such that an association is reflected between the tag(s) appearing on the asset(s) and the tracking device.

Problems arise, however, when the tracking device is removed from, or disassociated with the asset(s). For example, conventional tracking devices will often have rechargeable batteries. Thus, the tracking device, or the batteries therein, will need to be removed from time to time and recharged. But placing the tracking device back on, or associating the tracking device with the same asset(s) is difficult to manage. The problem with not placing the device back on or in association with the same asset(s), however, is that the association with the various assets in the database would then be out of date. Thus, either a lengthy and arduous process has to be undertaken in which the database has to be manually updated such that each asset previously associated with the old device is unassociated and then associated with a new device, or a difficult and time consuming process of making sure the same device goes back on the same assets as before must be undertaken. Neither of these approaches is particularly desirable.

### SUMMARY

The systems and methods described herein are directed to an improved system of asset tracking that allows a tracking device to be disassociated from an asset(s) and then placed on or associated with new assets, without the need for lengthy, difficult, and time consuming manual process for updating the database.

In a first exemplary aspect, an asset tracking system, comprises an asset; a tag comprising a tag identifier, the tag associated with the asset; a tracker comprising: a device identifier, a reader configured to read the tag identifier from the tag, and a transmitter configured to transmit the tag identifier and the device identifier to a server; a server configured to receive the transmitted tag identifier and device identifier, to associate them with each other, and to store the tag identifier, device identifier, and the association in a database.

In a second exemplary aspect, a method for asset tracking, comprises affixing a tag comprising a tag identifier to an asset; placing a tracker comprising a device identifier on or in proximity to the asset; reading the tag identifier from the tag using the tracker; transmitting the tag identifier and the device identifier to a server; receiving the transmitted tag identifier and device identifier; associating them with each other; and storing the tag identifier, device identifier, and the association in a database.

Other features and advantages of the present invention should become apparent from the following description of the preferred embodiments when taken in conjunction with the accompanying drawings.

### BRIEF DESCRIPTION OF THE DRAWINGS

Various embodiments disclosed herein are described in detail with reference to the following figures. The drawings are provided for purposes of illustration only and merely depict typical or exemplary embodiments. These drawings are provided to facilitate the reader's understanding of the invention and shall not be considered limiting of the breadth, scope, or applicability of the embodiments. It should be noted that for clarity and ease of illustration these drawings are not necessarily made to scale. Additionally, while several of the following figures refer specifically to RFID components, persons skilled in the art will understand that RFID is just one example of near field communication that can be used in certain embodiments. However, myriad other implementations of near field communication technology can be utilized in lieu of, or in addition to, the below referenced RFID systems.

FIG. 1 is a block diagram illustrating a conventional RFID transceiver adapted to receive signals reflected by passive RFID transponders as known in the art.

FIG. 2 is a flow diagram illustrating an improved method of asset tracking using the system of FIG. 2.

FIG. 3 is a block diagram illustrating an exemplary container which utilizes the improved asset tracking system according to one example embodiment.

The various embodiments mentioned above are described in further detail with reference to the aforementioned figured and the following detailed description of exemplary embodiments.

### DETAILED DESCRIPTION

In the following detailed description of certain embodiments, reference is made to the accompanying drawings in which like references indicate similar elements, and in which is shown by way of illustration. These embodiments are described in sufficient detail to enable those of ordinary skill in the art to practice the invention as claimed. The following detailed description is therefore not to be taken in a limiting sense.

A near field communication reader/tracker and a passive tag may be affixed to an item, for example, with an adhesive and a mounting bracket. Passive tags can then also be placed on each asset associated with the tagged item. Upon satisfaction of a certain condition, e.g., activation of a switch, expiration of a timer, an instruction from a remote controller, etc., the reader/tracker affixed to the tagged item can then read the information for the associated assets. This information can then be transferred to a remote database and logged to reflect all asset associations with the tracker.

When the tracker is removed, e.g., for recharging, it can simply be placed back onto any asset(s). The tracker will then read the associated tags for any associated new assets, and the new association(s) can be communicated to a remote server to update the database.

Before describing embodiments of the systems and methods described in more detail, the basic functioning of a system will be described. FIG. 1 is a block diagram illustrating a conventional RFID transceiver adapted to transmit an interrogation signal and receive reflected signals from passive RFID transponders as known in the art. As depicted in FIG. 1, an RFID system 100 typically includes an RFID transceiver 102, also known as an RFID reader, and one or more RFID transponders 110, i.e., the separate RFID tags that are affixed to various items intended to be tracked. RFID systems offer several key advantages over conventional bar-code scanners in that: i.) unlike conventional bar-code scanners, items bearing RFID tags can be scanned with an RFID reader even if the items are not in the direct line-of-sight of the RFID reader; and ii.) unlike conventional bar-code scanners, which require each item to be scanned individually, RFID readers can scan multiple items simultaneously or near-simultaneously. For example, all RFID-tagged items located within a certain read-radius can be scanned in a matter of mere seconds, if not sooner.

There are three different types of tags. “Passive” tags, e.g., transponders 110(1)-110(3) depicted in FIG. 1, operate by reflecting an interrogation signal 106 transmitted from the reader 102 to a receiving antenna. This receiving antenna is adapted to receive reflected “backscattered” signals 108 either at the RFID reader itself, e.g., at antenna 104, or at one or more other locations in the general vicinity of the passive tags 110. Because such “passive” tags 110 merely reflect and modulate a signal 106 that has already been transmitted from an reader 102, these reflected signals 108 are relatively weak, i.e., they are not amplified, and therefore, the reader 102, or at least, any receiving antennae, have to be positioned relatively close to the passive tags 110 in order for the reflected signals to be received and successfully read. Common examples of passive tag technology include RFID, ISO/IEC 14443 and FeliCa.

“Active” tags, by contrast, utilize an external source of power (such as a battery) so that the tag can transmit a stronger signal. While these tags are generally more expensive than passive tags (as they require a battery), they hold two advantages over passive tags due to the fact that they can transmit a stronger signal: i.) their data transmissions are more reliable/less prone to error; and ii.) such “active” tags can be situated farther away from the reader and still be successfully scanned. For example, in some cases, a tag can be situated over 30 feet away from the RFID reader. On the other hand, because such tags require a battery, they tend to be significantly larger and more expensive than passive tags which, as stated above, do not require any sort of battery. Common examples of active tag technology include Bluetooth, WiFi, ZigBee, Low Energy Bluetooth, and StoLPan,

“Semi-passive” tags are a hybrid blend of active and passive tags. These tags still utilize a battery, but the battery is used only to power the tag's microchip, i.e., it does not provide any power for signal transmission via the tag's antenna. Signals transmitted from the reader are therefore still reflected by “semi-passive” tags, and therefore such signals are still relatively weak. However, since the battery in a “semi-passive” tag is only used to power the microchip, its expected battery life is appreciably longer than that of active tags.

In many situations, tracking a large number of items via near field communication tags is a relatively straightforward process. First, tags, which have each been programmed/assigned unique identifiers, are affixed to each item intended to be tracked. A correspondence between a particular item, e.g., an automobile, and an tag may then be logged into a database, for example: Tag: “388234” Description: “2003 Ford Mustang GT”. A storage area such as a warehouse may then be periodically scanned by a reader for inventorying purposes. Optionally, all parties and vehicles entering or leaving a gated facility may be scanned at the gates in order to ensure that no tagged items are removed from the storage area without authorization.

In many cases, however, an item that is being tracked may have a number of smaller items contained within it, such as a suitcase, box, file cabinet, pallet, or other container, or it may have removable subcomponents that are necessary for the device to function, such as a plug-in module, a battery pack, cartridge, clip, disc, or other connectable unit, or the item may simply have a number of separately trackable items associated with it, even if such items are not physically contained within the item being tracked, e.g., various markers associated with a whiteboard.

In conventional systems of asset tracking, each asset that is separately trackable is typically identified with either a bar-code or a passive tag. There are at least three reasons for not using active or semi-active tags. First, tags which utilize batteries are more expensive than passive tags and bar codes. It may therefore be cost-prohibitive to include a separate battery-operated tag for each asset associated with a single item being tracked and this problem becomes more pronounced when progressively more assets become associated with a single item. Second, it may simply be too difficult to attach an active tag to certain assets due to spatial constraints. As mentioned above, active tags are a lot larger and therefore, require a lot more space than passive tags due to the fact that they require a battery. While attaching a battery-operated tag to a large asset may not present any type of issue, attaching a battery-operated tag to a small asset, such as battery used for an electronic device, may simply not be practical in many instances.

But regardless of the type of tag used, once each asset is tagged, the tag/asset information can be read by a reader/tracker. The tracker can, for example, be placed on the asset or a container containing the assets. The tracker can have its own identifier, and this identifier can then be associated with the asset identifiers. As noted above, this is typically a manual process. If the tracker is subsequently removed from, or disassociated with the assets, problems arise in that the tracker either needs to be returned to or associated with the same assets or the manual association process has to be performed again.

In the systems and methods described herein, however, passive, or other type of tags can be placed on the asset(s) as can a mobile asset tracker. This process is illustrated in FIG. 2, where, for example, in on embodiment, a bracket can be place on an asset in step 202, and the tag can be placed on or in the bracket in step 204. A mobile asset tracker can then be placed in the bracket in step 206. In some embodiments, the tracker can be positioned such that it can receive signals reflected from each of a number of passive tags that are affixed to various assets associated with the designated item. In some embodiments, multiple trackers and/or receiving antennae can be used in the alternative. The tracker can then read the tag in step 208 and send the tracker and tag identifier to a server application in step 210. The server application can then be configured to associate the tracker and the tag or asset in step 212. All further queries from the system for information related to the asset can then use data gathered from the identified, mobile asset tracker in step 214.

If the mobile tracker must be removed as shown in step 216, it can simply be placed back on any asset in step 218 and the process will simply repeat in order to update the tracker-asset association as needed.

For example, upon satisfaction of a certain condition, e.g., depressing a button, flipping a switch, detecting a power transition, expiration of a timer, receiving an instruction from a local or remote controller, receiving an interrupt or exception, a GPIO transition, etc., the tracker can be configured to transmit an interrogation signal to all tags within range. In response to this transmitted signal, the tags reflect that signal, with each reflected signal being modulated in such a manner so as to indicate each passive tag's unique identifier and/or other information. All tagged assets associated with the item can therefore be identified based upon which signals have been received. This information can then be transmitted to a server application for storage in a remote database. Automated scripts can then be used to update the database with the received information, i.e., the catalog of assets that are each associated with the tracker.

It should be noted that the association information can be stored on the tracker in certain embodiments and downloaded, or uploaded on demand or periodically.

Then, e.g., when the batteries of the tracker need to be recharged, it can simply be removed, recharged, and then placed back in association with an asset(s) where the association process can repeat, e.g., a program, script, process or other algorithm can then be used to automatically update the various asset associations stored in the database so that they no longer reference the initial tag(s), but instead reference a new tag(s).

This process also works when it is the passive tag that needs to be replaced for one reason or another. In other words, the initial tag can be removed from the item and replaced with the new tag and a new association process can be implemented to update the tracker-tag association.

FIG. 3 is a block diagram illustrating an exemplary container 302 that utilizes the improved asset tracking system according to certain embodiments. It will be understood that even though the tagged item depicted in FIG. 3 is a container 302, such a container 302 is merely one example of a tagged item that can be tagged in a system as described herein. A wide variety of other types of items can be used in lieu of a container, and such items need not necessarily serve to contain any of the assets 314 depicted in the figure as well.

As illustrated by FIG. 3, container 302 can include a storage compartment 305 for storing one or more assets 314(a)-314(e). Even though only five assets 314 are depicted in FIG. 3, it will be understood that any number of assets 314 can be stored in the storage compartment 305 in the alternative. Moreover, such assets 314 can involve items of different shapes, sizes, and weights.

Each of the assets 314 can have, e.g., a passive tag 316 affixed to it, with each passive tag 316 bearing a unique identifier. The passive tags can be affixed to the assets 314 in a wide variety of way, for example, via a clip, mounting bracket, adhesive, or seal.

Additionally, container 302 can include a bracket, clip, mount, etc., 310 and have, a, e.g., passive tag 312 mounted thereon or affixed thereto. A tracking device 304 can then be configured to attach to the container 302 via, e.g., bracket 310. It will be understood that a bracket is not necessary. Rather, the tag 310 can simply be affixed to the container 302 and tracker 304 can also be affixed, attached, coupled with, etc., container 302 in a close enough proximity to read tag 312.

Upon the occurrence of a certain condition, e.g., depressing a button, flipping a switch, detecting a power transition, expiration of a timer, receiving an instruction from a local or remote controller, receiving an interrupt or exception, a GPIO transition, etc., the tracker 304 can be configured to read tag 312, as well as any tags 316 associated with assets 314 within container 302. As such, tracker 304 can include a reader 308 configured to enable tracker 304 to read tags 312 and 316. For example, reader 308 can be a reader configured to transmit an interrogation signal. Each of the passive tags 312 and 316 can be configured to reflect that signal, modulating it in such a manner so as to indicate that passive tag's unique identifier and/or other information. Upon receiving signals reflected from each of the passive tags, the reader 308 may store such information in a local memory module, volatile and/or non-volatile, (not shown) that is disposed within the tracker 306. Optionally, the information may be time-stamped in order to assist with asset tracking.

In some embodiments, the received information can then be further transmitted to a remote computing device and/or remote database (not shown) via a transmitter 306, where one or more automated scripts can be used to update asset associations in the database based upon the received information.

It should be noted that transmitter 306 can be configured to transmit data over several different types of networks. These networks can include, without limitation, cellular networks, WiFi networks, satellite networks, wireless mesh networks, as well as any other environment where a communication path exists to a remote computing device, remote database, or backend application server. Note also that a wide variety of specific types of tags may also be used in accordance with embodiments described herein. Likewise, a wide variety of methods may be employed for processing the generated data and for modifying any relevant databases.

In certain specific implementations, operation for the tracking system is a WiFi or cellular based tracking device, for example, similar to the AT-3000 from Enfora Inc. Where the reader 308 is a reader, the reader can be configured to adhere to the ISO/IEC18000 standard, e.g., the ISO/IEC18000-3 standard. Myriad other implementations are also possible of course.

While various embodiments have been described above, it should be understood that they have been presented by way of example only, and not of limitation. The breadth and scope of the invention as claimed should not be limited by any of the above-described exemplary embodiments. Where this document refers to technologies that would be apparent or known to one of ordinary skill in the art, such technologies encompass those apparent or known to the skilled artisan now or at any time in the future. In addition, the invention is not restricted to the illustrated example architectures or configurations, but the desired features can be implemented using a variety of alternative architectures and configurations. As will become apparent to one of ordinary skill in the art after reading this document, the illustrated embodiments and their various alternatives can be implemented without confinement to the illustrated example. One of ordinary skill in the art would also understand how alternative functional, logical or physical partitioning and configurations could be utilized to implement the desired features of the present invention.

Furthermore, although items, elements or components of the invention may be described or claimed in the singular, the plural is contemplated to be within the scope thereof unless limitation to the singular is explicitly stated. The presence of broadening words and phrases such as “one or more,” “at least,” “but not limited to” or other like phrases in some instances shall not be read to mean that the narrower case is intended or required in instances where such broadening phrases may be absent.

What is claimed is:

1. An asset tracking system, comprising:
an asset;
a tag comprising a tag identifier, the tag associated with the asset;
a tracker comprising:
a device identifier,
a reader configured to read the tag identifier from the tag, and
a transmitter configured to transmit the tag identifier and the device identifier to a server;
a server configured to receive the transmitted tag identifier and device identifier, to associate them with each other, and to store the tag identifier, device identifier, and the association in a database.

2. The asset tracking system of claim 1, wherein the tag is a Radio Frequency Identification (RFID) tag and the reader is an RFID reader.

3. The asset tracking system of claim 2, wherein the RFID tag is a passive RFID tag.

4. The asset tracking system of claim 1, further comprising a bracket affixed to the asset, and wherein the tag is affixed to the bracket.

5. The asset tracking system of claim 4, wherein the tracker is configured to be coupled with the asset via the bracket.

6. The asset tracking system of claim 2, wherein the RFID reader is adapted to transmit an interrogation signal upon detecting a power state transition.

7. The asset tracking system of claim 2, wherein the RFID reader is adapted to transmit an interrogation signal upon determining that a switch has been actuated.

8. The asset tracking system of claim 2, wherein the RFID reader is adapted to transmit an interrogation signal upon expiration of a timer.

9. The asset tracking system of claim 1, further comprising a plurality of assets, and a plurality of tags each comprising a tag identifier and each associated with one of the plurality of assets, and wherein the reader is configured to read the tag identifiers from each of the plurality of tags, and the transmitter is configured to transmit the tag identifiers and the device identifier to a server.

10. The asset tracking system of claim 9, wherein the server is configured to receive the transmitted tag identifiers and device identifier, to associate each of the tag identifiers with the device identifier, and to store the tag identifiers, device identifier, and the associations in a database.

11. A method for asset tracking, comprising:
affixing a tag comprising a tag identifier to an asset;
placing a tracker comprising a device identifier on or in proximity to the asset;
reading the tag identifier from the tag using the tracker;
transmitting the tag identifier and the device identifier to a server;
receiving the transmitted tag identifier and device identifier;
associating them with each other; and
storing the tag identifier, device identifier, and the association in a database.

12. The method of claim 11, further comprising:
removing the tracker from proximity with the asset;
placing the tracker on a second asset comprising a tag with a second tag identifier;
reading the second tag identifier from the second tag using the tracker;
transmitting the second tag identifier and the device identifier to a server;
receiving the transmitted second tag identifier and device identifier;
associating the second tag identifier with the device identifier; and
storing the second tag identifier, the device identifier and the updated association of the second tag identifier with the device identifier in a database.

13. The method of claim 11, wherein the tag is a Radio Frequency Identification (RFID) tag and the tracker comprises an RFID reader.

14. The method of claim 13, wherein the RFID tag is a passive RFID tag.

15. The method of claim 11, further comprising affixing a bracket to the asset, and affixing the tag to the bracket.

16. The method of claim 15, further comprising coupling the tracker to the asset via the bracket.

17. The method of claim 11, wherein reading the tag identifier comprises sending an interrogation signal upon detecting a power state transition.

18. The method of claim 11, wherein reading the tag identifier comprises sending an interrogation signal upon determining that a switch has been actuated.

19. The method of claim 11, wherein reading the tag identifier comprises sending an interrogation signal upon expiration of a timer.

20. The method of claim 11, further comprising affixing a plurality of tags to a plurality of assets each of the tags comprising a tag identifier and each associated with one of the plurality of assets, reading the tag identifiers from each of the plurality of tags, and transmitting the tag identifiers and the device identifier to a server.

21. The method of claim 20, further comprising receiving the transmitted tag identifiers and device identifier, associating each of the tag identifiers with the device identifier, and storing the tag identifiers, device identifier, and the associations in a database.
